(19) United States
(12) Patent Application Publication
(10) Pub. No.: US 2025/0085102 A1
(43) Pub. Date: Mar. 13, 2025

(54) MEASUREMENT DEVICE AND MEASUREMENT METHOD

(71) Applicant: Kioxia Corporation, Tokyo (JP)

(72) Inventors: Shutaro OTSUKA, Yokohama (JP); Takuji OHASHI, Yokohama (JP); Kazuyuki MASUKAWA, Yokohama (JP); Takaki HASHIMOTO, Yokohama (JP)

(73) Assignee: Kioxia Corporation, Tokyo (JP)

(21) Appl. No.: 18/799,065

(22) Filed: Aug. 9, 2024

(30) Foreign Application Priority Data
Sep. 8, 2023 (JP) 2023-146083

(51) Int. Cl. G01B 11/06

(52) U.S. Cl. CPC G01B 11/0625; G01B 11/0675

(57) ABSTRACT

A measurement device includes a first light source configured to generate first light; a first beam splitter configured to split the first light into second light and third light; and a detector configured to receive signal light generated from a subject through irradiating the subject with the second light and the third light. The first light has a wavelength transmittable through a substrate. The second light is vertically incident on a surface of a first film formed on the subject. The third light is vertically incident on a rear surface of the substrate to be coaxial with the second light. A phase of transmitted light through the substrate is opposite to a phase of reflected light. An intensity of the transmitted light is equal to an intensity of the reflected light.

### CROSS-REFERENCE TO RELATED APPLICATION

This application is based upon and claims the benefit of priority from Japanese Patent Application No. 2023-146083, filed Sep. 8, 2023, the entire contents of which are incorporated herein by reference.

### FIELD

Embodiments described herein relate generally to a measurement device and a measurement method.

### BACKGROUND

A semiconductor device is manufactured by forming an element and a wiring pattern on a silicon wafer through each process such as film formation, exposure, and etching. When a fine pattern is formed over a multilayer, an uneven portion of a wafer surface increases. Since such a step difference may cause a defect in a device, an importance of a measurement device for measuring the step difference on the wafer surface is increasing.

### DESCRIPTION OF THE DRAWINGS

FIG. 1A is a view showing a structure of a subject.

FIG. 1B is a view showing a detected waveform in a detection unit.

FIG. 1C is a view showing a calculating method of a step difference based on the detected waveform.

FIG. 2 is a view showing light generated in a subject on which a transparent film is formed on a front surface.

FIG. 3A is an example of the detected waveform in the subject on which the transparent film is formed on the front surface.

FIG. 3B is an example of the detected waveform in the subject on which the transparent film is formed on the front surface.

FIG. 4A is a view schematically showing the light generated in the subject in Comparative Example.

FIG. 4B is an example of the detected waveform in Comparative Example.

FIG. 5A is a view schematically showing the light generated in the subject in the present embodiment.

FIG. 5B is an example of the detected waveform in the present embodiment.

FIG. 6 is a block diagram showing a configuration example of a measurement device according to the present embodiment.

FIG. 7 is a schematic view showing an optical comb.

FIG. 8 is a flowchart showing an example of a measurement method of the present embodiment.

FIG. 9A is a block diagram showing a configuration example of another measurement device according to the present embodiment.

FIG. 9B is a view showing a method of measuring a front surface shape of the subject via the measurement device shown in FIG. 9A.

FIG. 10A is a schematic view showing dual comb spectroscopy.

FIG. 10B is a schematic view showing the dual comb spectroscopy.

FIG. 10C is a block diagram showing a configuration of Modification Example of the measurement device of the present embodiment.

### DETAILED DESCRIPTION

In general, according to one embodiment, a measurement device includes a first light source configured to generate first light; a first beam splitter configured to split the first light into second light and third light; and a detector configured to receive signal light generated from a subject through irradiating the subject with the second light and the third light. The first light has a wavelength transmittable through a substrate. The second light is vertically incident on a surface of a first film formed on the subject. The third light is vertically incident on a rear surface of the substrate to be coaxial with the second light. A phase of transmitted light transmitted through the substrate among the third light is opposite to a phase of reflected light generated by a part of the second light being transmitted through the first film and being reflected on a front surface of the substrate. An intensity of the transmitted light is substantially equal to an intensity of the reflected light.

Hereinafter, embodiments will be described with reference to the accompanying drawings.

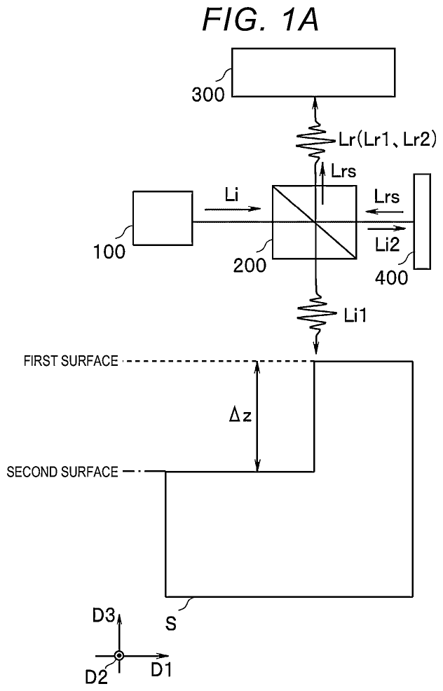

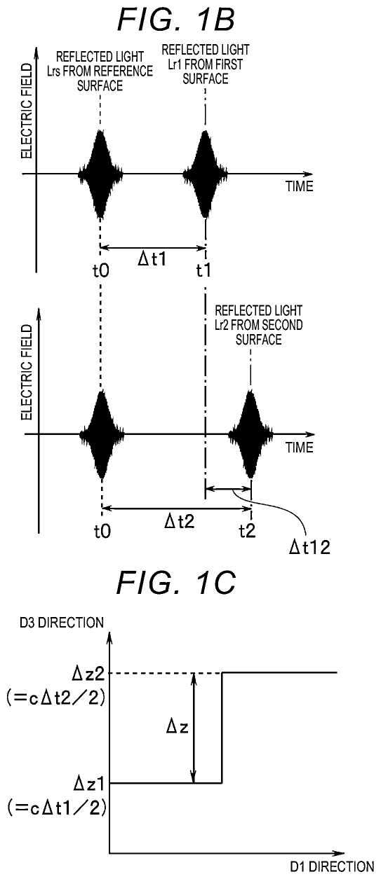

The measurement device of the present embodiment can measure, for example, a step difference formed on the front surface of the subject S. FIGS. 1A to 1C are views showing an example of a measurement principle of the step difference using the measurement device according to the present embodiment. FIG. 1A is a view showing a structure of the subject S. FIG. 1B is a view showing a detected waveform in a detection unit (or detector) 300. FIG. 1C is a view showing a calculating method of the step difference based on the detected waveform. In the subject S, a surface on which the step difference to be measured is formed is referred to as a front surface, and a surface facing the front surface is referred to as a rear surface. In the following drawings, two directions orthogonal to one another in a plane parallel to the rear surface of the subject S are referred to as a D1 direction and a D2 direction, respectively. Furthermore, a direction that is orthogonal to the rear surface of the subject S is referred to as a D3 direction. In the D3 direction, an upper side on the paper surface is referred to as a positive side (upward), and a lower side on the paper surface is referred to as a negative side (downward). In addition, in FIG. 1A, of the front surfaces of the subject S, the surface formed above is referred to as a first surface, and the surface formed below is referred to as a second surface.

As shown in FIG. 1A, the measurement light Li is emitted from the light source 100. The measurement light Li is split in the D1 direction and the D3 direction via the beam splitter 200. The light Li1 split in the D3 direction is vertically incident on the front surface of the subject S. First, when the irradiation region with the light Li1 is set to the first surface, the reflected light Lr1 is generated on the first surface. Meanwhile, the light Li2 split in the D1 direction is vertically incident on the surface of the reference mirror 400, and reflected light Lrs is generated. The reflected light Lr1 and the reflected light Lrs are synthesized by the beam splitter 200 and are detected by the detection unit 300. The detected waveform when the irradiation region with the light Li1 is set to the first surface is shown on the upper side of FIG. 1B. The detection times of the reflected light Lr1 and the reflected light Lrs are different according to the optical path difference. When the distance from the beam splitter 200 to the first surface is greater than the distance from the beam splitter 200 to the reference mirror 400, the reflected light Lr1 reaches the detection unit 300 with a delay compared to the reflected light Lrs. Therefore, as shown in the waveform on the upper side of FIG. 1B, the detection time t1 of the reflected light Lr1 is later than the detection time to of the reflected light Lrs. The distance difference ΔZ1 between the distance from the beam splitter 200 to the first surface and the distance from the beam splitter 200 to the reference mirror 400 may be calculated by multiplying the speed c of the reflected light Lr1 and the reflected light Lrs by the time difference Δt1 between the detection time to and the detection time t1 and dividing the result by 2.

Next, when the subject S is moved in the D1 direction to set the irradiation region with the light Li1 to the second surface, reflected light Lr2 is generated on the second surface. Meanwhile, the reflected light Lrs is generated from the reference mirror 400 by the irradiation with the light Li2. The reflected light Lr2 and the reflected light Lrs are synthesized by the beam splitter 200 and are detected by the detection unit 300. The detected waveform when the irradiation region with the light Li1 is set to the second surface is shown on the lower side of FIG. 1B. Since the distance from the beam splitter 200 to the second surface is greater than the distance from the beam splitter 200 to the reference mirror 400, the reflected light Lr2 reaches the detection unit 300 with a delay compared to the reflected light Lrs. Therefore, as shown in the waveform on the lower side of FIG. 1B, the detection time t2 of the reflected light Lr2 is later than the detection time to of the reflected light Lrs. The distance difference ΔZ2 between the distance from the beam splitter 200 to the second surface and the distance from the beam splitter 200 to the reference mirror 400 may be calculated by multiplying the speed c of the reflected light Lr2 and the reflected light Lrs by the time difference Δt2 between the detection time to and the detection time t2 and dividing the result by 2.

Finally, as shown in FIG. 1C, the step difference ΔZ between the second surface and the first surface may be calculated from the difference between the distance difference ΔZ2 and the distance difference ΔZ1. That is, in the measurement device of the embodiment, the step difference of the subject S is measured by calculating a height difference between the first surface and the second surface with the reference mirror 400 as a reference. In addition, when the distances from the beam splitter 200 to the reference mirror 400 are substantially equal at the time of measurement of the first surface and at the time of measurement of the second surface, the detection times to of the reflected light Lrs are substantially equal. Therefore, as shown in FIG. 1B, the step difference ΔZ between the second surface and the first surface can also be calculated by multiplying the speed c of the reflected light Lr1 and the reflected light Lr2 by the time difference Δt12 between the detection time t1 of the reflected light Lr1 and the detection time t2 of the reflected light Lr2 and dividing the result by 2. In addition, when the pulse light is used as the measurement light Li, the time difference Δt1 may be obtained from the phase difference between the reflected light Lr1 and the reflected light Lrs, and the time difference Δt2 may be obtained from the phase difference between the reflected light Lr2 and the reflected light Lrs.

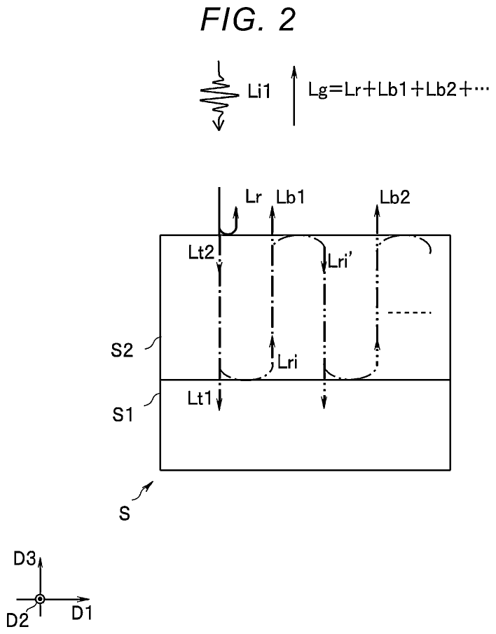

Next, a case where the step difference of the subject S on which the transparent film S2 is formed on the front surface of the substrate S1 is measured will be considered. The substrate S1 is, for example, a silicon substrate. The transparent film S2 is, for example, a silicon oxide film or a silicon nitride film. FIG. 2 is a view showing light generated in a subject on which a transparent film is formed on a front surface. When the transparent film S2 is formed on the front surface of the subject S, the measurement light Li1, which is emitted from above the transparent film S2, is divided into reflected light Lr, which is reflected on the surface of the transparent film S2, and transmitted light Lt2, which is transmitted through the transparent film S2. For example, when the transparent film S2 is a silicon oxide film, the proportion of the measurement light Li1 reflected on the surface of the transparent film S2 is approximately several percent (for example, 4%), and most of the measurement light Li1 is transmitted through the transparent film S2. When the transmitted light Lt2 reaches the interface between the transparent film S2 and the substrate S1, the transmitted light Lt2 is divided into the interface reflected light Lri reflected at the interface and the transmitted light Lt1 transmitted through the substrate S1. For example, when the transparent film S2 is a silicon oxide film and the substrate S1 is silicon, the proportion of the transmitted light Lt2 reflected at the interface between the transparent film S2 and the substrate S1 is approximately several tens of percent (for example, 40%).

When the interface reflected light Lri reflected at the interface between the transparent film S2 and the substrate S1 reaches the surface of the transparent film S2 (interface between the transparent film S2 and the air), the interface reflected light Lri is divided into the interface reflected light Lri′ reflected at the interface and the transmitted light transmitted from the surface of the transparent film S2 to the air. The transmitted light is, that is, background light Lb1 generated by the light Li1, which is applied to the subject S, being reflected at the interface between the transparent film S2 and the substrate S1. When the interface reflected light Lri′ reaches the interface between the transparent film S2 and the substrate S1, the interface reflected light Lri′ is divided into the interface reflected light reflected again at the interface and the transmitted light transmitted through the substrate S1. When the interface reflected light reaches the surface of the transparent film S2 (interface between the transparent film S2 and the air), the interface reflected light is divided into the interface reflected light reflected at the interface and the transmitted light transmitted from the surface of the transparent film S2 to the air. The transmitted light, that is, the background light Lb2 generated by the light Li1, which is applied to the subject S, being reflected twice at the interface between the transparent film S2 and the substrate S1 and once at the interface between the transparent film S2 and the air. In this way, the background light Lb1, the background light Lb2, . . . generated each time the transmitted light Lt2 is repeatedly reflected on the front surface of the substrate S1 are detected by the detection unit 300 together with the reflected light Lr. The light Lg shown in FIG. 2 indicates the light generated from the subject S by the irradiation with the light Li1, and is a synthesis of the reflected light Lr and the background light Lb1, the background light Lb2, . . . .

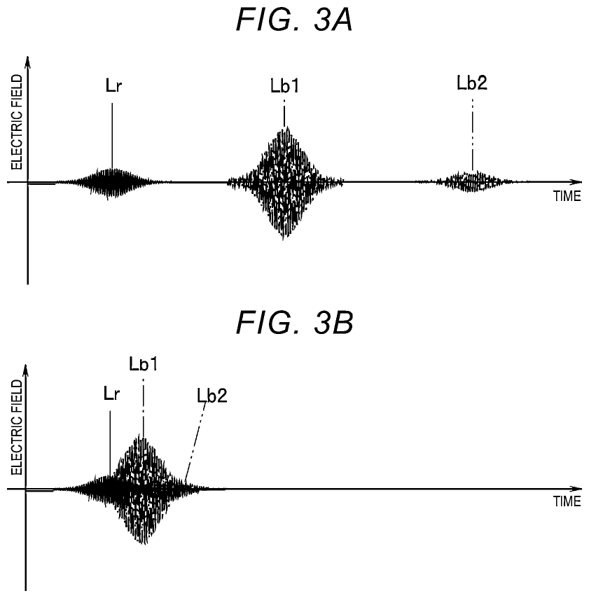

FIGS. 3A and 3B are examples of the detected waveform in the subject on which the transparent film is formed on the front surface. FIG. 3A shows an example of the detected waveform when a film thickness of a transparent film is great. When the film thickness of the transparent film S2 is great, the delay time of the background light Lb1 with respect to the reflected light Lr is long. In this case, as shown in FIG. 3A, the reflected light Lr and the background light Lb1 are detected at a predetermined interval. In this way, when the waveform of the reflected light Lr and the waveform of the background light Lb1 are separated and detected, it is possible to extract the waveform of the reflected light Lr from the detected waveform. Therefore, the reflected light Lr from the front surface of the subject S can be accurately measured.

FIG. 3B shows an example of the detected waveform when a film thickness of a transparent film is small. When the film thickness of the transparent film S2 is small, the delay time of the background light Lb1 with respect to the reflected light Lr is short. In this case, as shown in FIG. 3B, the waveforms of the reflected light Lr and the background light Lb1 overlap each other. In this way, when the waveform of the reflected light Lr and the waveform of the background light Lb1 are overlapped and detected, it is difficult to extract the waveform of the reflected light Lr from the detected waveform. Therefore, the reflected light Lr from the front surface of the subject S cannot be accurately measured. In the semiconductor device, a transparent film (a silicon oxide film or a silicon nitride film) formed on a silicon substrate includes, for example, a film having a very small film thickness of several tens of nm. When measuring the step difference formed on the surface of such a thin film, as shown in FIG. 3B, a possibility that the reflected light Lr and the background light Lb1 overlap each other is high.

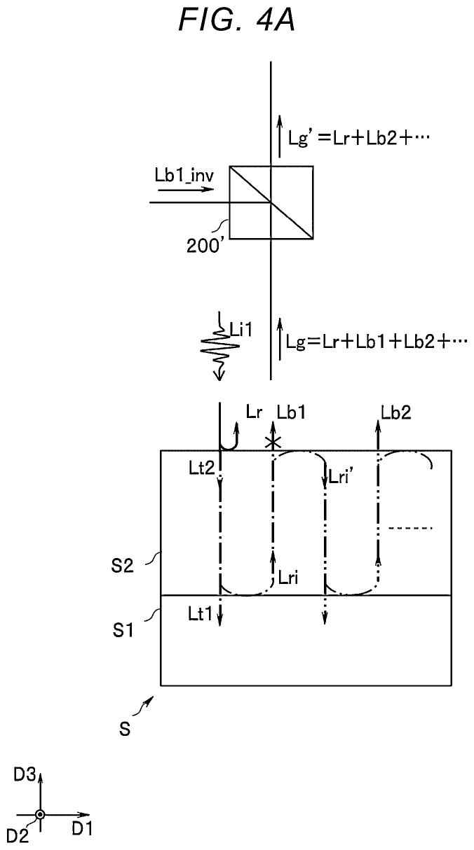

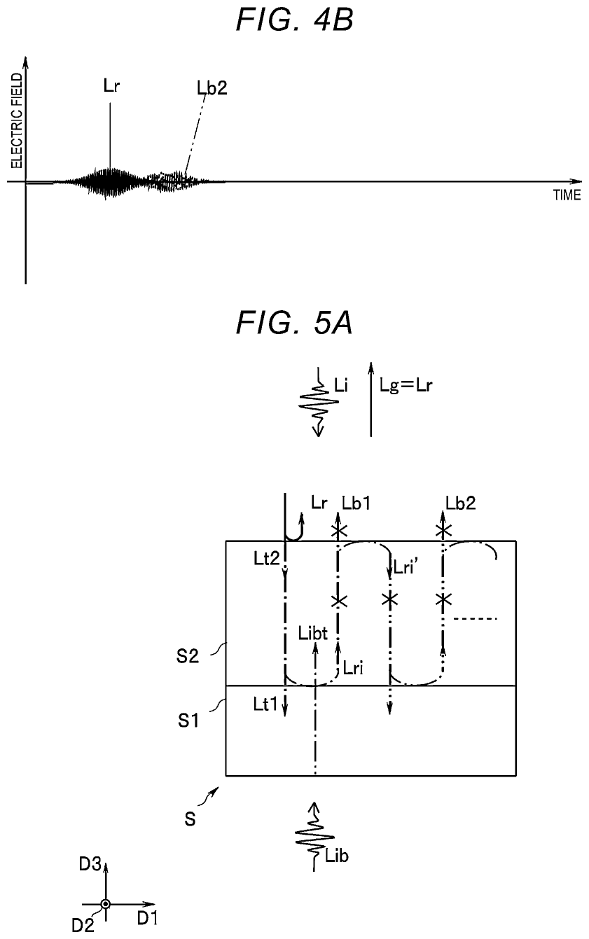

As a method of removing the background light Lb1 to be noise, a method of synthesizing the light with a substantially equal intensity and an opposite phase to the background light Lb1 with respect to the light Lg generated from the subject S is considered. FIGS. 4A and 4B are views showing an example of light generated in Comparative Example. FIG. 4A is a view schematically showing the light generated in the subject in Comparative Example. FIG. 4B is an example of the detected waveform in Comparative Example. As shown in FIG. 4A, the beam splitter 200′ is used to merge the light Lb1_inv with a substantially equal intensity and an opposite phase to the background light Lb1 with the light Lg generated from the subject S. The background light Lb1 is offset by the light Lb1_inv, so that the light Lg′ output from the beam splitter 200′ does not include the component of the background light Lb1. Therefore, the background light Lb1 is not detected by the detection unit 300. Meanwhile, in the case of Comparative Example, the background light Lb2, . . . generated by the multiple reflections of the interface reflected light Lri′ cannot be removed.

Therefore, as shown in FIG. 4B, the detection unit 300 also detects the background light Lb2 in addition to the reflected light Lr. When the film thickness of the transparent film S2 is small, the reflected light Lr and the background light Lb2 overlap each other, so that it is difficult to extract the waveform of the reflected light Lr from the detected waveform. Therefore, even in the method of Comparative Example, the reflected light Lr from the front surface of the subject S cannot be accurately measured.

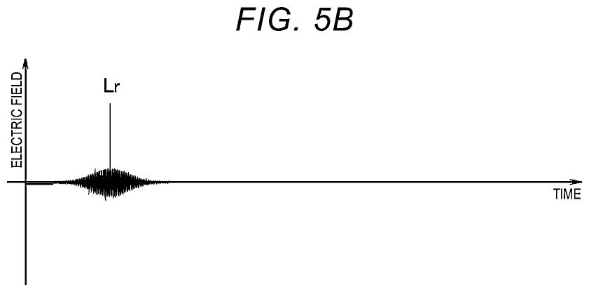

Meanwhile, the measurement device according to the embodiment applies the light with a substantially equal intensity and an opposite phase to the reflected light Lri from the rear surface of the subject S upward in the D3 direction. FIGS. 5A and 5B are views showing an example of light generated in the measurement device of the present embodiment. FIG. 5A is a view schematically showing the light generated in the subject in the present embodiment. FIG. 5B is an example of the detected waveform in the present embodiment. As shown in FIG. 5A, the rear surface incident light Lib is incident on the surface of the transparent film S2 from the opposite direction to the measurement light Li, that is, from below in the D3 direction. The light, which is incident on the transparent film S2 by being transmitted through the substrate S1 among the rear surface incident light Lib, is referred to as transmitted light Libt. The intensity of the rear surface incident light Lib is set such that the intensity of the transmitted light Libt is substantially equal to the intensity of the interface reflected light Lri. In addition, the phase of the rear surface incident light Lib is adjusted such that the phase of the transmitted light Libt is opposite to that of the interface reflected light Lri. Since the interface reflected light Lri is offset by the rear surface incident light Lib, the background light Lb1 is not generated. In addition, the interface reflected light Lri′ is not generated because the interface reflected light Lri is offset. That is, the background light Lb2, . . . are also not generated. Therefore, the light Lg generated from the subject S is substantially equal to the reflected light Lr, and thus the reflected light Lr can be extracted from the detected waveform as shown in FIG. 5B. Therefore, according to the measurement device of the present embodiment, the reflected light Lr of the front surface of the subject S can be accurately measured.

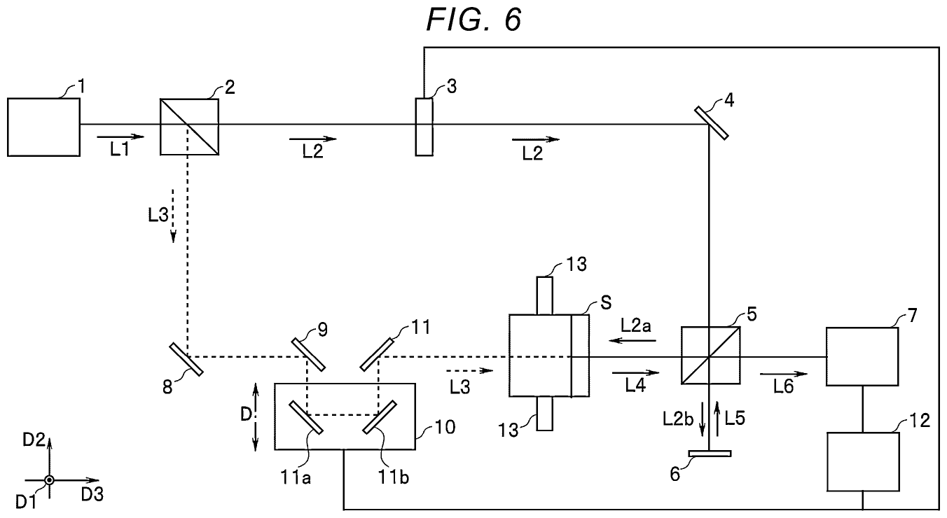

Next, a configuration of the measurement device according to the present embodiment will be described. FIG. 6 is a block diagram showing a configuration example of the measurement device according to the present embodiment. The measurement device according to the present embodiment includes a light source 1, beam splitters 2 and 5, a variable neutral density (ND) filter 3, a plurality of mirrors 4, 8, 9, and 11, a reference mirror 6, a delay line 10, and a detection unit 7. In addition, the measurement device according to the present embodiment includes a control arithmetic unit (or controller) 12 and a subject holding unit (or holder) 13.

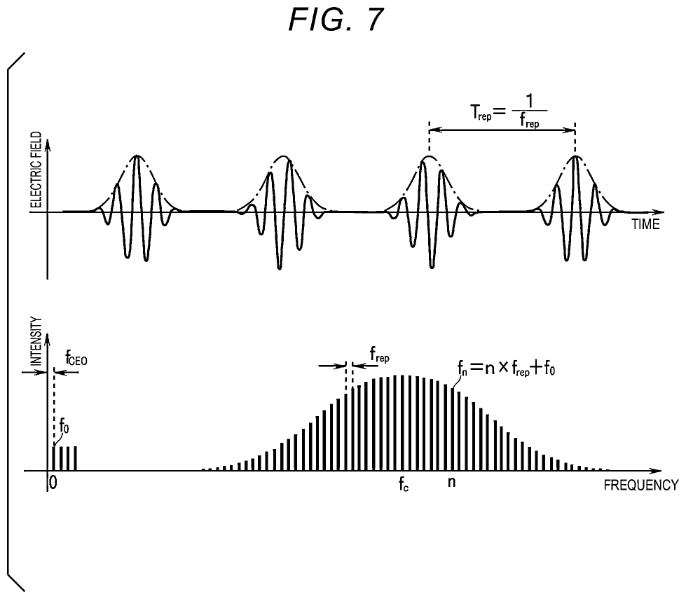

The light source 1 generates light (light L1) to be applied to the subject S which is a measurement target, and emits the light. For example, an optical frequency comb (optical comb) is used as the light L1. FIG. 7 is a schematic view showing the optical comb. In FIG. 7, an upper stage is a view showing an electric field distribution on a time axis, and a lower stage is a view showing an intensity distribution on a frequency axis. The optical comb is a series of ultrashort pulse light having an extremely short time width of several fs to several ps at constant intervals on the time axis. The spectrum is a comb-like arrangement of a large number of frequency modes having narrow line widths at constant intervals on the frequency axis.

As shown in the upper stage of FIG. 7, a relational expression shown in Expression (1) is established between a repetition time Tᵣₑₚ and a repetition frequency fᵣₑₚ of the optical pulse train oscillated at a constant repetition.

fᵣₑₚ=1/Tᵣₑₚ (1)

The optical pulse train is configured with a carrier (bold line in the upper stage of FIG. 7) which is a superposition wave of a large number of narrow spectra, and a wave packet constituting an envelope (one-dot chain line in the upper stage of FIG. 7) of the carrier. When the above-described optical pulse train is subjected to Fourier transform on the time axis and observed on the frequency axis, as shown in the lower stage of FIG. 7, a large number of optical frequency modes are observed to be arranged at intervals of the repetition frequency fᵣₑₚ corresponding to a reciprocal number of the repetition time Tᵣₑₚ. The optical comb includes an optical frequency mode f₀ having a predetermined carrier envelope offset (CEO, offset frequency) f_{CEO} with respect to zero on the frequency axis, and a plurality of optical frequency modes fₙ arranged at intervals of an integer multiple of a predetermined repetition frequency fᵣₑₚ with respect to the optical frequency mode f₀ on the frequency axis. A frequency f(n) of the n-th spectrum of the optical comb is represented by Expression (2) with the repetition frequency fᵣₑₚ and the carrier envelope offset f_{CEO} as parameters.

f(n)=n×fᵣₑₚ+f_{CEO} (2)

The optical comb can measure a frequency, a distance, and the like with high accuracy and is widely used as a “precise ruler”. That is, by using the optical comb as the measurement light, the step difference formed on the front surface of the subject S can be measured with high accuracy.

The beam splitter 2 splits the light L1 emitted from the light source 1 into first probe light L2 and second probe light L3. The first probe light L2 is incident on the variable ND filter 3, which is a variable neutral density filter. The second probe light L3 is adjusted in the optical path direction by the mirrors 8 and 9 and then is incident on the delay line 10.

The variable ND filter 3 reduces the light amount of the first probe light L2 incident from the beam splitter 2. The light reducing amount in the variable ND filter 3 is set in the control arithmetic unit 12. The first probe light L2 emitted from the variable ND filter 3 is adjusted in the optical path direction by the mirror 4 and then is incident on the beam splitter 5.

The beam splitter 5 splits the first probe light L2 emitted from the variable ND filter 3 into measurement light L2a and reference light L2b. The measurement light L2a is vertically incident on the front surface of the subject S. The reference light L2b is incident on the reference mirror 6.

The reference mirror 6 is installed at a predetermined distance from the beam splitter 5. The reference light Lb2 is reflected by the reference mirror 6 to generate reflected reference light L5. The reference mirror 6 may be formed of a material that is less likely to scatter the reflected reference light L5. The reference mirror 6 may be formed of, for example, a resin or a ceramic instead of a mirror. In addition, the transparent film S2 formed thickly (for example, about several μm) on the substrate S1 may be used as the reference mirror 6.

The delay line 10 delays the second probe light L3 for a set time. The delay line 10 includes two total reflection prisms 11a and 11b in which respective reflection surfaces face each other. The delay line 10 moves along the arrow D, so that the optical path length of the second probe light L3 changes, and a predetermined delay time is added. The delay time added to the delay line 10 is set in the control arithmetic unit 12. The second probe light L3 emitted from the delay line 10 is adjusted in the optical path direction by the mirror 11 and then is vertically incident on the rear surface of the subject S. The measurement light L2a and the second probe light L3 are incident on the subject S so that the optical axis of the measurement light L2a and the optical axis of the second probe light L3 are matched.

In the subject S, as shown in FIG. 2, the transparent film S2 is formed on the front surface of the substrate S1. A step difference is formed on the surface of the transparent film S2, and the measurement device of the embodiment measures the step difference. The subject S is held by the subject holding unit 13, and the position of the subject S is fixed during measurement. The subject holding unit 13 may be a clamp that fixes the position by clamping two side surfaces of the subject S facing each other, or may be a stage that supports the rear surface of the subject S.

A part of the measurement light L2a incident on the front surface of the subject S is reflected on the surface of the transparent film S2 of the subject S (reflected light Lr). In addition, a part of the measurement light L2a is transmitted through the transparent film S2 (transmitted light Lt2), is reflected at the interface between the transparent film S2 and the substrate S1, and goes into interface reflected light Lri. When the refractive index of the substrate S1 is greater than the refractive index of the transparent film S2, the phase of the interface reflected light Lri is inverted with respect to the transmitted light Lt2. For example, when the substrate S1 is silicon and the transparent film S2 is a silicon oxide film or a silicon nitride film, the phase of the interface reflected light Lri is inverted. Meanwhile, at least a part of the second probe light L3, that is, the rear surface incident light Lib, which is incident on the rear surface of the subject S, is incident on the transparent film S2 by being transmitted through the substrate S1 (transmitted light Libt).

In a path from the light L1 to the generation of the interface reflected light Lri, the light L1 is reflected by the mirror 4 and the beam splitter 5 and at the interface between the transparent film S2 and the substrate S1. That is, in this path, the light is reflected three times, and phase inversion occurs in each reflection. Therefore, the phase of the interface reflected light Lri is a phase opposite to the phase of the light L1. Meanwhile, in a path from the light L1 to the generation of the rear surface incident light Lib, the light L1 is reflected by the beam splitter 2, the mirrors 8, 9, and 11, and the total reflection prisms 11a and 11b. That is, in this path, the light is reflected six times, and phase inversion occurs in each reflection. Therefore, the phase of the rear surface incident light Lib is the same phase as the phase of the light L1. In this way, in the measurement device of the embodiment, the number of times of reflections in each path is set to be in an even/odd relationship with each other such that the phase of the interface reflected light Lri and the phase of the rear surface incident light Lib are in opposite phase.

By adjusting the phase of the rear surface incident light Lib such that the intensity of the transmitted light Libt is substantially equal to the intensity of the interface reflected light Lri and the phase of the interface reflected light Lri and the phase of the transmitted light Libt are in opposite phase, the interface reflected light Lri can be offset. By adjusting the variable ND filter 3, the light amount of the measurement light L2a can be increased or decreased, and the intensity of the interface reflected light Lri can be made substantially equal to the intensity of the transmitted light Libt. Furthermore, regarding the phase of the interface reflected light Lri and the phase of the transmitted light Libt, the transmitted light Libt can be locked to the interface reflected light Lri by adjusting the optical path length of the second probe light L3 via the delay line 10. The variable ND filter 3 may be disposed in an optical path of the second probe light L3. In addition, the delay line 10 may be disposed in an optical path of the first probe light L2. As described above, the interface reflected light Lri is offset by the transmitted light Libt. Therefore, the signal light L4, which is a synthesis of the light generated by the subject S by the measurement light L2a and the light generated by the subject S by the second probe light L3, can be regarded to correspond to the reflected light Lr.

The signal light L4 and the reflected reference light L5 are synthesized by the beam splitter 5 to be a synthetic signal light L6, and the synthetic signal light L6 is received by the detection unit 7. The detection unit 7 includes, for example, a photodiode, and the detection unit 7 detects a waveform of the synthetic signal light L6.

In the control arithmetic unit 12, a phase difference between the reflected reference light L5 and the signal light L4 is calculated from the waveform of the synthetic signal light L6 detected by the detection unit 7. The calculation of the step difference in the control arithmetic unit 12 is performed, for example, as follows. First, the phase difference between the signal light L4 (=Lr1) and the reflected reference light L5 (=Lrs) is obtained from the waveform of the synthetic signal light L6 obtained when the measurement light L2a is applied to the first surface of the subject S. The time difference Δt1 between the signal light L4 and the reflected reference light L5 is obtained from the phase difference between the signal light L4 and the reflected reference light L5. Next, the phase difference between the signal light L4 (=Lr2) and the reflected reference light L5 (=Lrs) is obtained from the waveform of the synthetic signal light L6 obtained when the measurement light L2a is applied to the second surface of the subject S. The time difference Δt2 between the signal light L4 and the reflected reference light L5 is obtained from the phase difference between the signal light L4 and the reflected reference light L5. The difference between the time difference Δt1 and the time difference Δt2 is calculated, and the time difference Δt12 between the signal light Lr1 and the signal light Lr2 is obtained. The time difference Δt12 is multiplied by the speed of the signal light L4 and the result is divided by 2 to calculate the step difference ΔZ between the first surface and the second surface.

The control arithmetic unit 12 also sends an instruction for increasing or decreasing the light reducing amount to the variable ND filter 3 and an instruction for increasing or decreasing the optical path length to the delay line 10, based on the waveform of the synthetic signal light L6 detected by the detection unit 7.

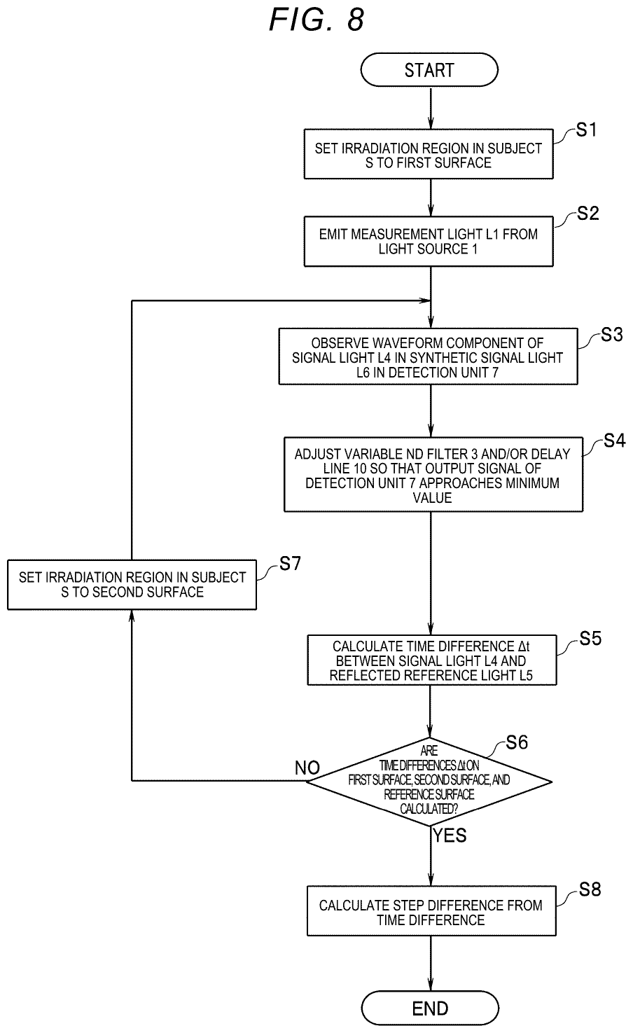

Next, a measurement method of a step difference using the measurement device of the embodiment will be described with reference to FIG. 8. FIG. 8 is a flowchart showing an example of a measurement method of the present embodiment. First, a step difference to be a measurement target in the subject S is specified, and an irradiation region is set such that the measurement light L2a is applied to the first surface, that is, an upper surface of the step difference (S1). Next, the light L1 (for example, an optical comb) is emitted from the light source 1 (S2).

As described above, the light L1 is split into the first probe light L2 and the second probe light L3 by the beam splitter 2. The measurement light L2a split from the first probe light L2 by the beam splitter 5 is vertically incident on the irradiation region of the subject S from the front surface side (upper side in the D3 direction). The second probe light L3 is vertically incident on the irradiation region of the subject S from the rear surface side (lower side in the D3 direction) to be coaxial with the measurement light L2a. The signal light L4 generated from the subject S by irradiation with the measurement light L2a and the second probe light L3 is incident on the detection unit 7 via the beam splitter 5. The detection unit 7 observes the waveform component of the signal light L4 in the synthetic signal light L6 (S3). The light reducing amount of the variable ND filter 3 and the delay amount of the delay line 10 are adjusted so that the output signal of the detection unit 7 approaches a minimum value (S4).

When the output signal of the detection unit 7 is sufficiently small and the adjustment of the light reducing amount of the variable ND filter 3 and the delay amount of the delay line 10 is completed, the phase difference between the reflected reference light L5 and the signal light L4 is obtained based on the waveform component of the reflected reference light L5 and the waveform component of the signal light L4 in the synthetic signal light L6. Further, a time difference Δt between the reflected reference light L5 and the signal light L4 is calculated from the phase difference (S5). Here, since the irradiation region is the first surface of the subject S, the time difference Δt1 is calculated.

When the time differences Δt on the first surface and the second surface of the subject S and on the reference surface are not calculated (S6, NO), after moving the irradiation region (S7), the series of procedures from S3 to S5 are repeated. In the above description, only the time difference Δt1 on the first surface of the subject S is calculated, so that the process proceeds to S7, and the irradiation region on the subject S is set to the second surface (lower surface of the step difference). The series of procedures from S3 to S5 are executed for the second surface, and the time difference Δt2 on the second surface is calculated.

When the time differences Δt on the first surface and the second surface of the subject S and on the reference surface are calculated (S6, YES), the time differences Δt1 and Δt2 are used to calculate the step difference ΔZ (S8), and the series of procedures are ended.

As described above, with the measurement device according to the embodiment, when measuring the step difference on the surface of the transparent film S2 of the subject S on which the transparent film S2 is formed on the substrate S1, the second probe light L3 is also emitted from the rear surface of the subject S as the rear surface incident light Lib when the measurement light L2a is emitted from the front surface of the subject S. The transmitted light Libt incident on the transparent film S2 by being transmitted through the substrate S1 among the second probe light L3, and the interface reflected light Lri have opposite phases to each other and a complementary intensity relationship. The interface reflected light Lri is offset by the transmitted light Libt in which the phase and the intensity are adjusted as described above, so that the generation of the background light Lb1 and the interface reflected light Lri′ is prevented. Therefore, the reflected light Lr from the surface of the transparent film S2 can be detected without being affected by the background light Lb1 and the interface reflected light Lri′, and the step difference on the front surface of the subject S can be accurately measured.

Further, according to the measurement method of the embodiment, the waveform component of the signal light L4 from the subject S is observed in a state where the measurement light L2a is incident on the front surface of the subject S and the second probe light L3 is incident on the rear surface of the subject S. The phase of the second probe light L3 is adjusted by the delay line 10, or the intensity of the measurement light L2a is adjusted by the variable ND filter 3 until the background light Lb1 is sufficiently removed from the waveform component of the signal light L4 and the waveform of the reflected light Lr can be extracted. Therefore, the reflected light Lr from the surface of the transparent film S2 can be detected in a state where the background light Lb1 is sufficiently removed, and the step difference on the front surface of the subject S can be accurately measured.

The light L1 is not limited to the above-described optical comb. The light L1 may be light having a wavelength that is transmitted through the substrate S1, and for example, a pulse laser or a CW laser may be used. In addition, the transparent film S2 is not limited to the silicon oxide film or the silicon nitride film described above. The transparent film S2 may be a film through which the measurement light L2a is transmitted and which does not scatter the transmitted light Lt2, and for example, may be a resin film, a ceramic film, or the like.

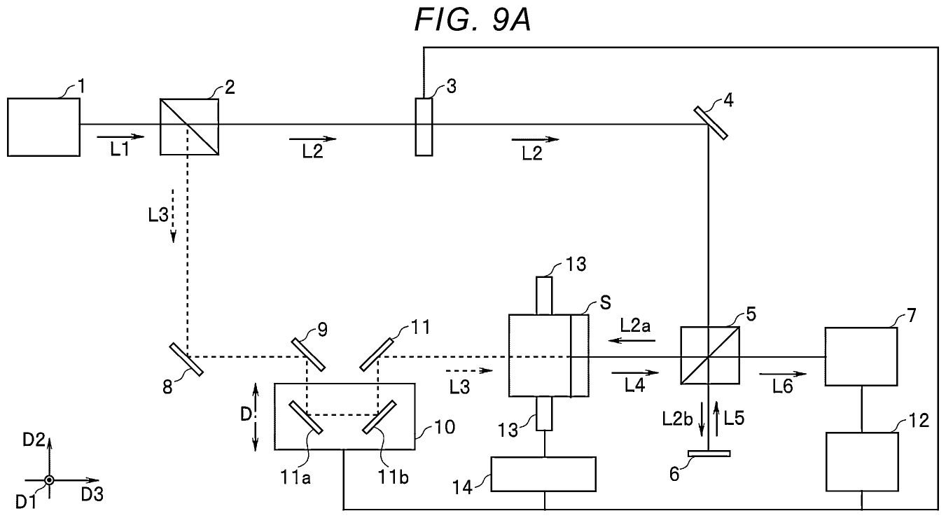

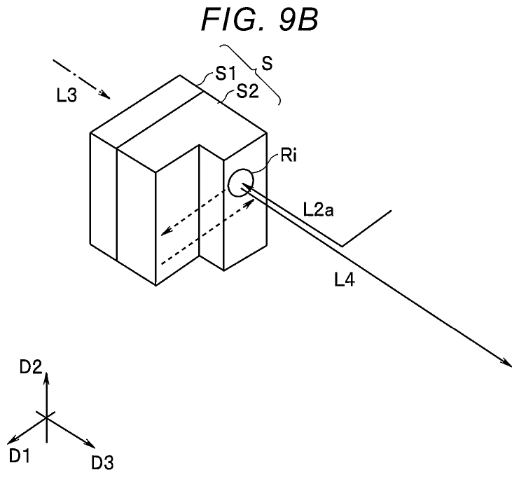

Although the measurement of the step difference between two points in the subject S has been described above, the measurement device according to the embodiment can also measure the shape of the uneven portion of the front surface in the measurement region set in the subject S. FIG. 9A is a block diagram showing a configuration example of another measurement device according to the present embodiment. FIG. 9B is a view showing a method of measuring a front surface shape of the subject via the measurement device shown in FIG. 9A.

The measurement device shown in FIG. 9A further includes holding unit driving mechanism (or driver) 14 in addition to the configuration of the measurement device shown in FIG. 6. In FIG. 9A, the same elements as the elements shown in FIG. 6 are denoted by the same reference numerals, and the description thereof will be omitted. The holding unit driving mechanism 14 moves the subject holding unit 13 in the D1 direction and the D2 direction. During measurement, the irradiation region may be moved in a state where the optical axes of the measurement light L2a and the second probe light L3 are matched by moving the subject holding unit 13 in the D1 direction or/and the D2 direction in a state where the subject S is held. In addition, since the distance between the beam splitter 5 and the reference mirror 6 does not change even when the irradiation region is moved, the optical path length of the reflected reference light L5 can be kept constant. The operation of the holding unit driving mechanism 14 is controlled by the control arithmetic unit 12.

FIG. 9B shows an enlarged view of the measurement region of the shape of the uneven portion of the front surface of the subject S. As shown in FIG. 9B, for example, in a measurement region set in a rectangular shape with one side of several hundreds of μm, N regions of the irradiation target regions Ri (i=1, 2, . . . , N) are set as irradiation regions (for example, with a diameter of several μm) with the measurement light L2a. The subject holding unit 13 is moved by the holding unit driving mechanism 14 and the position of the subject S is set so that the measurement light L2a is applied to the first irradiation target region R1. After the position of the subject S is fixed, the synthetic signal light L6 in the irradiation target region R1 is acquired by the above-described measurement method, and the time difference Δt1 with respect to the reference surface is acquired. After the measurement of the irradiation target region R1 is completed, the subject holding unit 13 is moved so that the measurement light L2a is applied to the next irradiation target region R2. The synthetic signal light L6 in the irradiation target region R2 is acquired by the above-described measurement method, and the time difference Δt2 with respect to the reference surface is acquired. In this way, N number of the time differences Δti for the reference surface are acquired by acquiring the synthetic signal light L6 while shifting the position of the irradiation region. The distance differences ΔZi from the reference surface in the respective irradiation target regions Ri are calculated from the time differences Δti. By mapping the distance differences ΔZi using the coordinates of each irradiation target region Ri, the shape of the uneven portion of the front surface in the measurement region can be measured.

In the measurement device shown in FIG. 6, in the optical comb of the light L1 emitted from the light source 1, a center frequency fc is several hundreds of THz while a repetition frequency fᵣₑₚ is approximately 100 MHz to GHz as shown in FIG. 7. The observation is difficult with the spectrometer because the repetition frequency fᵣₑₚ is too narrow with respect to the center frequency fc. Further, the interval of the optical pulses is very narrow, from several fs to several ps, and it is difficult to measure the phase. Therefore, a measurement device having a configuration in which two optical comb light sources are provided may be used to perform measurement via dual comb spectroscopy.

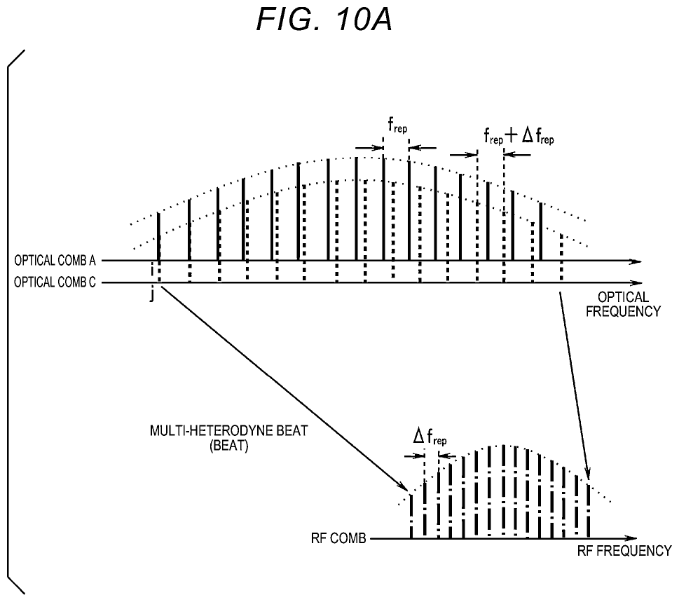

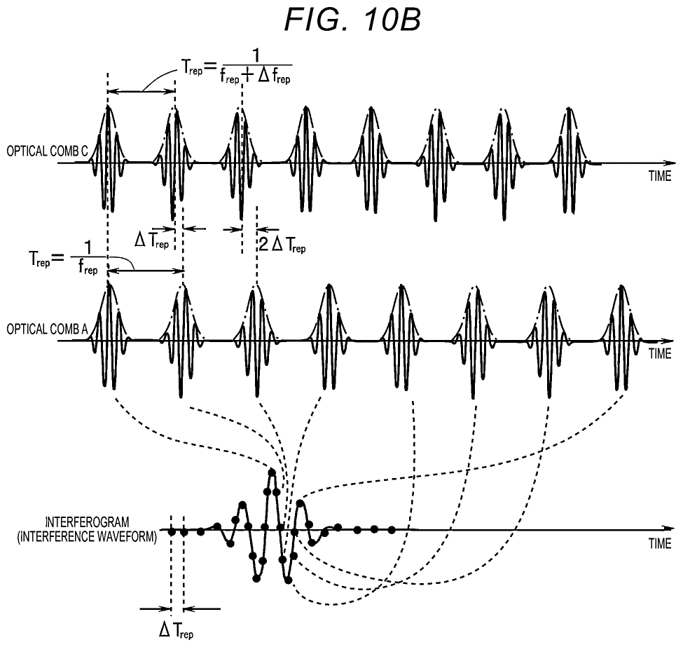

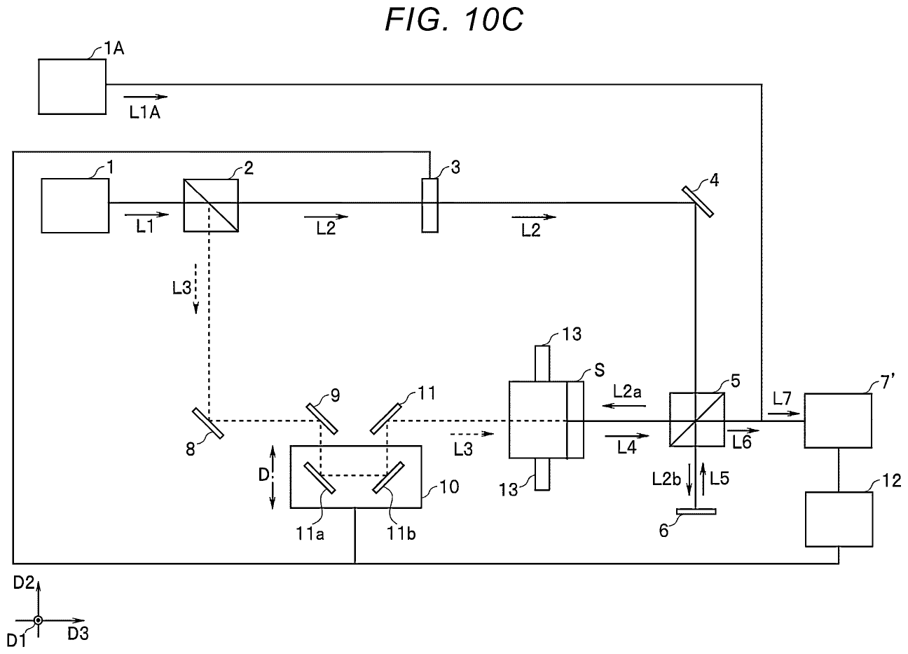

FIGS. 10A and 10B are schematic views showing the dual comb spectroscopy. The dual comb spectroscopy is a technique for acquiring information on each optical frequency mode of an optical comb, and can accurately measure a physical property of a sample, for example. As shown in FIG. 10A, the optical comb A having a repetition frequency fᵣₑₚ and the optical comb B having a repetition frequency fᵣₑₚ+Δfᵣₑₚ are used, and the optical comb B is transmitted through the sample. When the optical comb C, which is transmitted through the sample and includes optical information of the sample, interferes with the optical comb A, beats are generated, and the beat signal becomes a radio frequency comb having the repetition frequency Δfᵣₑₚ. For example, the repetition frequency fᵣₑₚ of the optical comb A is set to 100.000 MHz, and the repetition frequency fᵣₑₚ+Δfᵣₑₚ of the optical comb B is set to 100.001 MHz. Further, the i-th optical frequency mode of the optical comb A and the j-th optical frequency mode of the optical comb B are controlled to match each other. At this time, the beat between the i+1-th spectrum of the optical comb A and the j+1-th spectrum of the optical comb C appears at the frequency Δfᵣₑₚ=1 KHz. Similarly, the i+m-th spectrum of the optical comb A appears at m KHz. Thereby, since the repetition frequency of 100 MHz in the optical frequency can be converted into a radio frequency to be reduced 10⁻⁵ times (=1 kHz), a waveform of the optical comb C including the optical information of the sample can be observed as an electrical signal, and each optical frequency mode can be separated and observed.

Further, when two optical combs A and C shown in FIG. 10A are represented on a time axis, as shown in FIG. 10B, a pulse of the optical comb A and a pulse of the optical comb C are different from each other in a period by a time ΔTᵣₑₚ. A waveform (interferogram) obtained by interfering the two optical combs A and C with each other is a waveform obtained by temporally extending the optical comb C. The optical comb C has a short period and is difficult to measure. Meanwhile, a waveform obtained by interfering two optical combs with each other has a long period. Since the interference waveform may be observed with an oscilloscope or the like, the waveform of the optical comb C can be measured, and the optical information of the sample can be accurately acquired.

FIG. 10C is a block diagram showing a configuration of Modification Example of the measurement device of the present embodiment. The measurement device of Modification Example includes a second light source 1A in addition to each of the elements shown in FIG. 6. In addition, the light L1 emitted from the light source 1 and the light L1A emitted from the second light source 1A are both optical combs. The repetition frequency f_{rep_1A} of the light L1A is set to be slightly different from the repetition frequency f_{rep_1} of the light L1. The light L1A corresponds to the above-described optical comb A, and the light L1 corresponds to the above-described optical comb B.

The optical beat signal L7 is generated by causing the signal light L6 corresponding to the above-described optical comb C to interfere with the light L1A. The optical beat signal L7 has a waveform in which the signal light L6 is temporally extended as described above. When a difference between the repetition frequency f_{rep_1A} and the repetition frequency f_{rep_1} is Δf_{rep_1}, the optical beat signal L7 has a spectrum at an interval of Δf_{rep_1}. As described above, when the frequency of the radio frequency band is set as Δf_{rep_1}, the optical beat signal L7 goes into an electrical signal and can be accurately observed with an oscilloscope or the like. Thereby, the delay time can be measured more accurately. In this way, by configuring the measurement device in a dual comb, the step difference on the front surface of the subject S can be measured more highly accurately.

Although the case of measuring the step difference of the front surface of the subject S has been described as an example above, the measurement device of the present embodiment can also be applied to the monitoring of the film quality (for example, refractive index, absorption coefficient, and the like) of the front surface of the subject S in addition to the shape such as the step difference. For example, when light is not absorbed in the transparent film S2, it is possible to obtain the refractive index of the transparent film S2 from the intensity ratio of the reflected light Lg to the incident light Li. Further, the measurement device of the embodiment can also be applied to process monitoring. For example, the measurement device of the embodiment can be applied when inspecting the shape of the uneven portion of the surface of the wafer after a predetermined step such as a film forming step in a manufacturing step of a semiconductor device. In addition, at each of the two time points in the film forming step, the surface of the wafer is measured using the measurement device of the embodiment, and the distance difference from the reference surface is calculated, so that the measurement device of the embodiment can also be applied to monitoring of the film forming amount, and the like.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A measurement device, comprising:
a first light source configured to generate first light;
a first beam splitter configured to split the first light into second light and third light; and
a detector configured to receive signal light generated from a subject through irradiating the subject with the second light and the third light,
wherein the first light has a wavelength transmittable through a substrate,
the second light is vertically incident on a surface of a first film formed on the subject,
the third light is vertically incident on a rear surface of the substrate to be coaxial with the second light,
a phase of transmitted light transmitted through the substrate among the third light is opposite to a phase of reflected light generated by a part of the second light being transmitted through the first film and being reflected on a front surface of the substrate, and
an intensity of the transmitted light is substantially equal to an intensity of the reflected light.

2. The measurement device according to claim 1, wherein the first light is an optical frequency comb having a predetermined offset frequency with respect to zero on a frequency axis and a plurality of first frequency components arranged at intervals of an integer multiple of a first repetition frequency with respect to the offset frequency.

3. The measurement device according to claim 2, further comprising:
a second light source configured to generate fourth light,
wherein the fourth light is an optical frequency comb having the offset frequency and a plurality of second frequency components arranged at intervals of an integer multiple of a second repetition frequency with respect to the offset frequency,
the second repetition frequency is obtained by adding a beat frequency to the first repetition frequency, and
the beat frequency is a radio frequency.

4. The measurement device according to claim 1, further comprising:
a variable neutral density filter,
wherein the variable neutral density filter is disposed in an optical path of either one of the second light or the third light.

5. The measurement device according to claim 1, further comprising:
a delay line configured to delay transmission of light,
wherein the delay line is disposed in an optical path of either one of the second light or the third light.

6. The measurement device according to claim 5, wherein the delay line includes a pair of total reflection prisms, with their reflection surfaces facing each other.

7. The measurement device according to claim 1, further comprising:
a second beam splitter provided on an optical path of the second light between the first beam splitter and the surface of the first film,
wherein a first one of light split by the second beam splitter is vertically incident on the surface of the first film.

8. The measurement device according to claim 7, further comprising:
a reference mirror, wherein a second one of the light split by the second beam splitter is vertically incident on the reference mirror.

9. The measurement device according to claim 8, wherein a distance from the second beam splitter to the surface of the first film and a distance from the second beam splitter to a surface of the reference mirror are different from each other.

10. The measurement device according to claim 1, further comprising:
a holder configured to hold the subject in a posture in which the second light and the third light are coaxially and vertically incident on the subject; and
a driver configured to move the holder such that an irradiation region of the subject with the second light and the third light is moved while maintaining the posture.

11. The measurement device according to claim 10, further comprising:
a controller configured to calculate a front surface state of the subject based on the signal light generated in a different irradiation region of the subject by the driver moving the holder.

12. The measurement device according to claim 1, wherein a first number of times of light reflections is counted on an optical path after the first light is generated from the first light source until the reflected light is generated and a second number of times of light reflections is counted on an optical path after the first light is generated from the first light source until the transmitted light is transmitted through the substrate, and wherein one of the first and second numbers is an even number, with the other of the first and second numbers being an odd number.

13. A measurement method, comprising:
generating first light having a wavelength transmittable through a substrate;
splitting the first light into second light and third light;
causing the second light to be vertically incident on a surface of a first film formed on the substrate;
causing the third light to be vertically incident on a rear surface of the substrate to be coaxial with the second light;
adjusting respective intensities and respective delay times of the second light and the third light, such that transmitted light transmitted through the substrate among the third light and reflected light generated by a part of the second light being transmitted through the first film and being reflected on a front surface of the substrate have opposite phases to each other and a complementary intensity relationship;
detecting signal light generated from a subject including the first film through irradiating the subject with the second light and the third light; and
monitoring the surface of the first film based on the signal light.

14. The measurement method according to claim 13, wherein the first light is an optical frequency comb having a predetermined offset frequency with respect to zero on a frequency axis and a plurality of first frequency components arranged at intervals of an integer multiple of a first repetition frequency with respect to the offset frequency.

15. The measurement method according to claim 14, further comprising:
causing a fourth light, which is an optical frequency comb having the offset frequency and a plurality of second frequency components arranged at intervals of an integer multiple of a second repetition frequency with respect to the offset frequency, to interfere with the transmitted light based on the first light.

16. The measurement method according to claim 13, further comprising:
splitting the second light before the second light is incident on the surface of the first film,
wherein one of split light is incident on the surface of the first film and the other of the split light is vertically incident on a reference mirror.

17. The measurement method according to claim 13, wherein a first number of times of light reflections is counted on an optical path after the first light is generated until the reflected light is generated and a second number of times of light reflections is counted on an optical path after the first light is generated until the transmitted light is transmitted through the substrate, and wherein one of the first and second numbers is an even number, with the other of the first and second numbers being an odd number.

18. The measurement method according to claim 17, wherein a refractive index of the substrate is greater than a refractive index of the first film.

19. The measurement method according to claim 13, wherein an irradiation region of the subject with the second light and the third light is moved, and the signal light generated from the subject is detected in each of irradiation regions.

20. The measurement method according to claim 13, wherein the signal light generated from the subject is detected at each of a plurality of time points in a predetermined process with respect to the substrate.
